(19) United States
(12) Patent Application Publication
(10) Pub. No.: US 2016/0042480 A1
(43) Pub. Date: Feb. 11, 2016

(54) GENERATION OF COST ESTIMATES FOR OFFSHORE STRUCTURE DESIGNS

(71) Applicant: CONOCOPHILLIPS COMPANY, Houston, TX (US)

(72) Inventors: Ivica T. GRGAS, Houston, TX (US); Dominique P. BERTA, Flower Mound, TX (US)

(21) Appl. No.: 14/740,521

(22) Filed: Jun. 16, 2015

Related U.S. Application Data
(60) Provisional application No. 62/013,301, filed on Jun. 17, 2014.

(51) Int. Cl. G06Q 50/16

(52) U.S. Cl. CPC G06Q 50/165

(57) ABSTRACT

An embodiment of a method of assessing characteristics of a proposed offshore structure design includes: receiving input data from a user via a user interface, the input data including characteristics of a proposed design of an offshore structure; estimating, by a processor, a weight of the offshore structure and expected forces on the structure based on the input data; calculating allowable stresses and stability of the offshore structure based on the estimated weight and expected forces; estimating a cost of fabrication of the offshore structure based on the input data; estimating a cost of transportation and installation of the offshore structure based on the input data; calculating a total estimated cost of the offshore structure based on the cost of fabrication and the cost of transportation and assembly; and outputting the estimated weight, expected forces and total cost to the user via a display.

### CROSS-REFERENCE TO RELATED APPLICATIONS

This application is a non-provisional application which claims benefit under 35 USC §119(e) to U.S. Provisional Application Ser. No. 62/013,301 filed Jun. 17, 2014, entitled “GENERATION OF COST ESTIMATES FOR OFFSHORE STRUCTURE DESIGNS.”

### BACKGROUND OF THE INVENTION

Design of ocean systems, including various types of floating platforms and vessels, requires many considerations. Among such considerations are storage capacity, stability in various weather and ocean conditions, manufacturing and/or assembly time, and cost.

Estimating properties, characteristics and costs of a floating structure design is typically a complex and time-consuming process. Generating such estimates generally requires numerous software packages, a significant amount of computation, and coordination of information gathering from multiple parties.

### SUMMARY OF THE INVENTION

An embodiment of a method of assessing characteristics of a proposed offshore structure design includes: receiving input data from a user via a user interface, the input data including characteristics of a proposed design of an offshore structure; estimating, by a processor, a weight of the offshore structure and expected forces on the structure based on the input data; calculating allowable stresses and stability of the offshore structure based on the estimated weight and expected forces; estimating a cost of fabrication of the offshore structure based on the input data; estimating a cost of transportation and installation of the offshore structure based on the input data; calculating a total estimated cost of the offshore structure based on the cost of fabrication and the cost of transportation and assembly; and outputting the estimated weight, expected forces and total cost to the user via a display.

An embodiment of a system for assessing characteristics of a proposed offshore structure design includes a processing device configured to execute a cost estimate program stored on a machine-readable medium, a cost estimate program including an input module, an estimation module and an output module. The input module is configured to receive input data from a user via a user interface, the input data including characteristics of a proposed design of an offshore structure. The estimation module is configured to receive the input data and perform: estimating a weight of the offshore structure and expected forces on the structure based on the input data; calculating allowable stresses and stability of the offshore structure based on the estimated weight and expected forces; estimating a cost of fabrication of the offshore structure based on the input data; estimating a cost of transportation and installation of the offshore structure based on the input data; and calculating a total estimated cost of the offshore structure based on the cost of fabrication and the cost of transportation and assembly. The output module is configured to output and display the estimated weight, expected forces and total cost to the user.

A method of assessing characteristics of a proposed offshore structure design includes: receiving input data from a user via a user interface, the input data including characteristics of a proposed design of an offshore structure, the characteristics including a type of structure, dimensions of the structure, a description of components of the structure, and a description of the structure mission and environment for use of the structure; constructing a panel model of the proposed structure by retrieving one or more generic panel models based on the input data, and modifying the generic panel model based on the dimensions; estimating, by a processor, a weight of the offshore structure and expected forces on the structure based on the input data; calculating allowable stresses and stability of the offshore structure based on the estimated weight and expected forces, wherein calculating the allowable stresses includes calculating extreme force values based on the expected forces and comparing the extreme force values to allowable values, the allowable values calculated based on stress design code equations; outputting the calculated allowable stresses, the comparison and the calculated stability to the user to allow the user to change the proposed design if desired; estimating a cost of fabrication of the offshore structure based on the input data; estimating a cost of transportation and installation of the offshore structure based on the input data; calculating a total estimated cost of the offshore structure based on the cost of fabrication and the cost of transportation and assembly; and outputting the estimated weight, expected forces and total cost to the user via a display.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 depicts an embodiment of a data processing and cost estimation system;

FIG. 2 depicts exemplary offshore structures for which cost estimates may be produced;

FIG. 3 is a flow chart illustrating an embodiment of a method of estimating costs associated with proposed offshore structure designs; and

FIG. 4 is a workflow depicting performance of an exemplary cost estimation method performed by a processor executing a computer program.

### DETAILED DESCRIPTION

Apparatuses, systems and methods are provided for providing cost estimates for offshore structure designs based on user input data. In one embodiment, a tool or other computer program product executes an algorithm or computer program to estimate offshore structure characteristics and output estimates of costs associated with the offshore structure. For example, a comprehensive tool includes input interfaces to allow a user to input design and/or measurement data (e.g., topside center-of-gravity coordinates, design specifications, riser data, etc.). The tool calculates or predicts various characteristics of the proposed offshore structure (e.g., dimensions, mass properties, hydrostatic and hydrodynamics characteristics, risers and mooring particulars), and based on the characteristics, estimates costs of construction, transportation and installation.

The embodiments described herein provide tools that enable calculation of multiple floating structure characteristics (e.g., stability, weight estimate, mooring and riser analysis, global response, cost estimate) with minimum user interaction with any other commercial software package, including cost estimate.

The tools perform calculations using already existing functions, newly defined functions and/or Visual basic macros. Results may be presented in any suitable formation, e.g., tabular and/or graphical forms. Such comprehensive tools save time, add confidence in cost estimates and contribute to better communication among different departments inside an operator company and between operators and contractors during the floating structure cost estimate process.

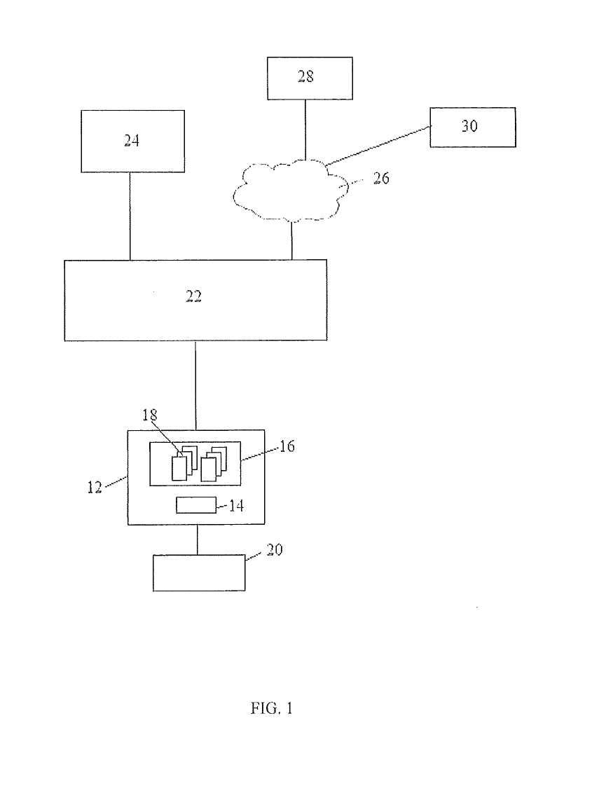

Referring to FIG. 1, an embodiment of a data processing and cost estimate system 10 is shown. The system 10 includes a processing device or unit 12 such as a computer (e.g., desktop or laptop). The processing unit 12 includes a processor 14 and a memory 16 that stores suitable software or programs 18, and also stores input data and algorithms for performing various modeling, computation and cost estimation processes. Output data including structure properties and cost estimates may be presented to a user via a display 20 or other suitable output means.

The processing unit 12 may be connected to a host 22, which includes suitable processors, storage, input/output interfaces and other components for storing, transmitting and receiving data. The processing unit 12 and the host 22 are not limited to the configurations described herein, and may include any suitable device or network including various processors, memory and communications devices.

The host 22 and/or the processing unit 12 may include or be connected to one or more databases or other storage devices 24 to store data such as design data, manufacturer data, generic models, input data related to proposed designs, and output data calculated by a cost estimate/prediction program. The storage device(s) 24 may be internal or external to the host and/or processing unit. In addition, the host 22 and/or the processing unit 12 may be connected via the internet or other network 26 to various external databases 28, 30.

The methods described herein can be performed or executed on the client computer, the host or any other processing unit or combination of processing units. A processing device (e.g., the processing unit 12 and/or host 22) is configured to receive input data related to proposed designs or plans for an offshore structure (e.g., a floating platform or vessel), and output cost estimate information based on the input data.

In one embodiment, an exemplary computer program utilizes a suite of spreadsheets (e.g., a workbook) to allow a user to input what is known about the requirements of a particular design. A user inputs design information to one or more sheets, which in turn provide all of the information to a single program that calculates cost estimates. For example, other sheets in the workbook are included for performing calculations.

Input data can be taken from various sources. In addition to input data provided by a user, the program can take user information and retrieve information from manufacturers or service providers. For example, the program can request equipment lists, component costs and materials, and estimates of costs from contractors or service providers, such as transportation companies and platform installers.

For instances where information required for the cost estimate is not provided by a user (to accommodate differing stages of project maturity) default generic data may be provided where practicable.

In one embodiment, the processing device stores multiple panel models (also referred to simply as panels) that describe various types and configurations of floating or offshore structures and components, and can be used by the program for cost estimation. The program selects one or more panels based on input from the user (e.g., a user selects a generic panel that applies to a proposed design, or the user provides a panel), and using input information such as platform and/or platform element dimensions, planned location or use, calculates forces that will be incident on the platform.

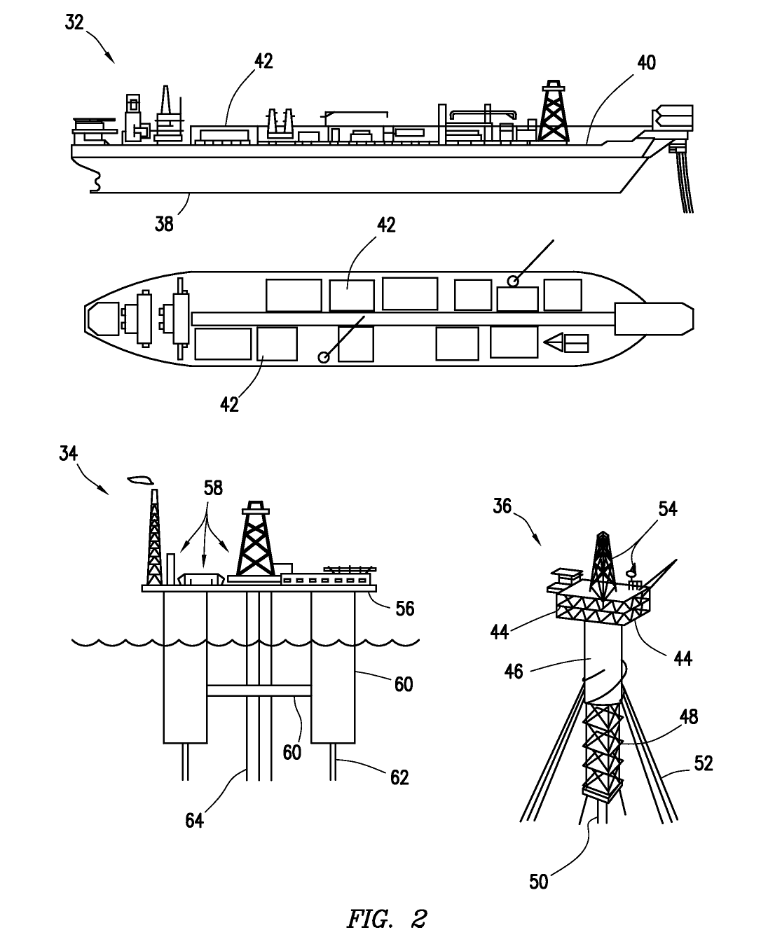

Exemplary offshore platform designs are shown in FIG. 2, which illustrates examples of a floating vessel 32, such as a floating production, storage and offloading (FPSO) unit, a tension leg platform (TLP) and/or semi-submersible floating platform 34 (referred to as a TLP/Semi structure) and a spar platform 36 such as a truss spar. Offshore structure designs are not limited to the specific examples described herein.

Various elements of a proposed offshore structure design may be modeled, e.g., via panel models, either individually or in combination. Exemplary elements of the floating vessel 32 include a hull 38, a deck 40, storage tanks and various equipment assemblies 42, as well as mooring lines, risers and associated support structures. Exemplary elements of the truss spar 36 include decks 44, a hull 46, trusses 48, risers 50, mooring lines 52 and equipment assemblies 54 (e.g., drill rig, storage tanks) Exemplary elements of the TLP/Semi structure 34 include a deck 56, equipment assemblies 58, columns 60, tendons 62, risers 64, pontoons 66 and mooring lines.

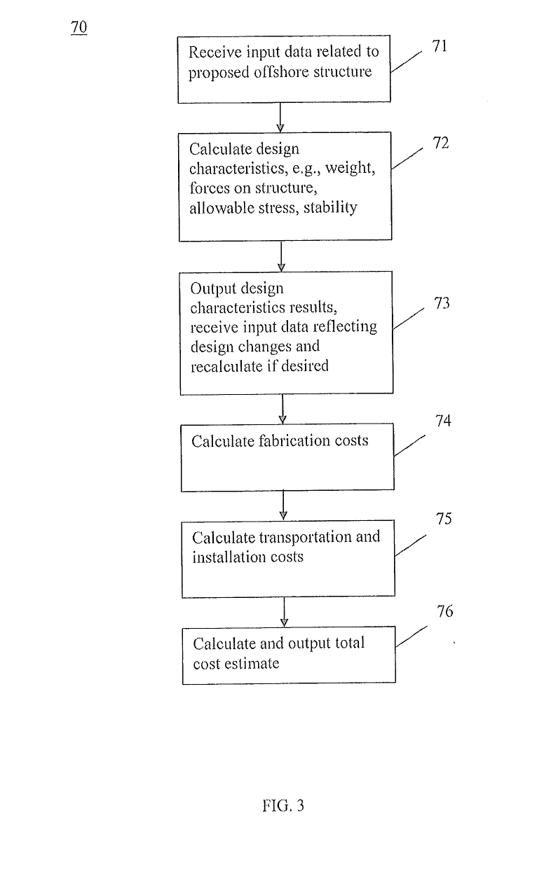

FIG. 3 is a flowchart depicting an exemplary method 70 of generating one or more cost estimates for an offshore or floating platform. The method 70 may be performed on any suitable processor, processing device and/or network, such as the processing system 10 or components thereof. The method 70 includes one or more stages 71-76. In one embodiment, the method 70 includes the execution of all of stages 71-76 in the order described. However, certain stages may be omitted, stages may be added, or the order of the stages changed.

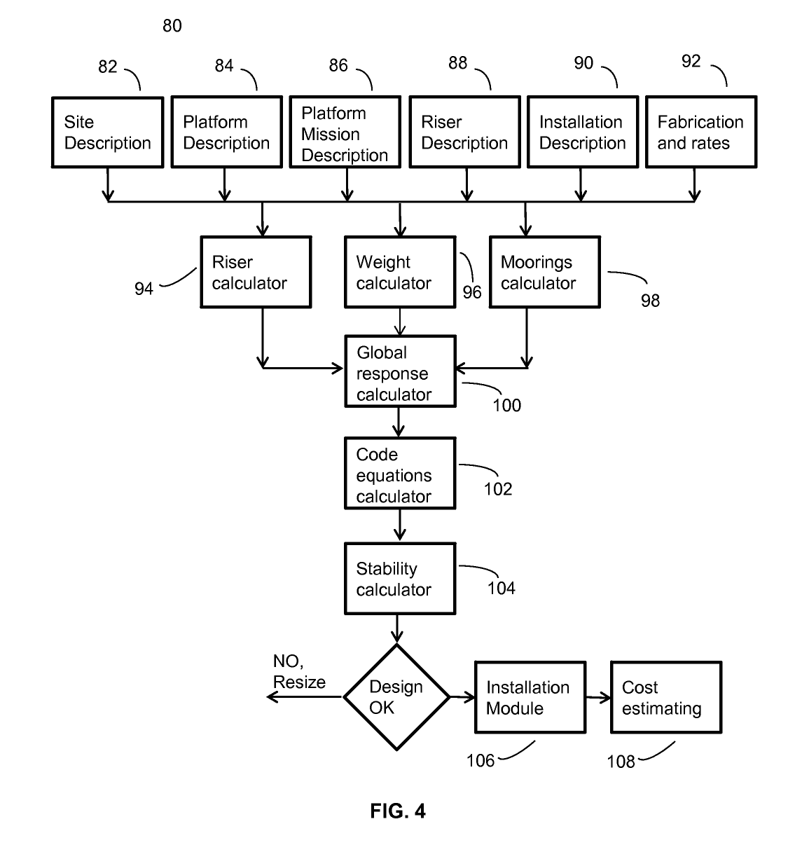

The method 70 is described in conjunction with an example shown in FIG. 4. FIG. 4 shows a workflow 80 performed by a processor in executing a cost estimate program.

An exemplary computer program that can be used to perform the method 70 is is configured as a spreadsheet workbook. Individual spreadsheets in the workbook provide various functions, including receiving input data, calculating characteristics and costs using the input data, and outputting cost estimate data and other information of interest to a user. Programs or algorithms that can be used to perform the method 70 are not limited to those described herein. Any suitable program that is capable of receiving input data, performing calculations (e.g., including calculation and application of models) and presenting cost estimates to a user may be used.

In the first stage 71, input data is received by a processor. The input data may be received from a human or machine (collectively referred to as a “user”) via suitable input interfaces and/or mechanisms. For example, the program includes one or more spreadsheets that include text boxes for a user to input data.

The input data may be any type of data or information that can be used to estimate costs associated with a proposed offshore or floating structure. Exemplary data includes design data, manufacturing and assembly data, transportation data and proposed use data (e.g., location, duration, expected conditions).

Such information may include platform or structure design information, such as the type of platform or structure (e.g., floating ship, TLP, etc.), dimensions and components. Exemplary dimension information includes principle dimensions specified as top-flight dimensions and/or dimensions of structure components or elements (e.g., columns, pontoons, equipment boxes, etc.). Another example of input data is weight center of gravity coordinates (x, y, z) of the proposed structure or the top-side of the structure (e.g., the deck). A description (e.g., size, shape and/or weight) of equipment located on the structure, as well as the distribution of the equipment, may also be included as input data.

For example, the workflow 80 includes receiving various types of input data. The program receives one or more of site description data (block 82), platform description (block 84), platform mission description information (block 86), riser description (block 88), installation description (block 90) and fabrication and rates information (block 92).

The program may include one or more input modules such as spreadsheets that include input features such as text boxes. Other interfaces may be used (e.g., GUIs).

In the second stage 72, the processor calculates platform design characteristics. Design characteristics include properties and features of the proposed structure, which are related to fabrication costs, i.e., the cost of fabrication, purchase and assembly of the structure. Such characteristics include the platform weight (total weight and/or weight of individual elements) and loading characteristics such as estimated forces on the structure, allowable stress and stability.

For example, the workflow 80 includes a riser calculator 94. A calculator or other program component (e.g. a riser calculator spreadsheet or spreadsheet portion) estimates riser characteristics including, e.g., riser length, path and tension, estimated forces on the riser, fatigue life and dynamic responses. The workflow 80 also includes a weight calculator 96 and a mooring calculator 98. The mooring calculator 98 utilizes input data (e.g., platform type, mooring type and tension, mooring material and anchor type) to calculate characteristics related to fabrication costs.

In one embodiment, the program computes the total platform weight based on input information, including platform descriptions, vessel type, principal dimensions, riser descriptions and/or descriptions of equipment to be supported on the platform or vessel. Additional information may be utilized, e.g., information acquired from component manufacturers. For example, based on the input platform description, the required components, component materials and weight information for particular components can be acquired from a database, the internet or other source of data.

In one embodiment, the program is configured to develop one or more forcing models for the proposed structure. The proposed structure may be represented by a single model or multiple models. For example, models are constructed based on the type of platform input by the user (i.e., the generic configuration) and dimensions and configurations of elements of the proposed structure that have been input by the user.

In one embodiment, the models are based on a specification of relatively few element types and their dimensions. The models estimate force information based on the primary components or elements of a platform or structure such as vessel type, platform type, major equipment (e.g., drilling rig, liquid natural gas production and/or storage, rectangular boxes, etc.) and the number, type and/or configurations of elements such as risers, columns, pontoons, tendons and others.

The program performs platform forcing using suitable hydrodynamic principles and equations. For example, for some platform options (e.g., columns, pontoons, etc.), an efficient Morison model may be selected by the user. This may include the use of MacCamy-Fuchs type, wave-diffraction models for surface piercing elements. In another example, linear-diffraction hydrodynamic coefficients may be computed and used.

In one embodiment, platform forcing is calculated using the panel method. A model is constructed by discretizing the structure or elements thereof using a number of panels. The structures constructed and modeled using the panel method are referred to herein as “panel models.”

The processor, in one embodiment, analyzes the panel models in a way that limits the required calculations to those necessary to provide a reasonable cost estimate, without requiring full detail of all structure components and features. For example, by limiting the analysis to major elements of the proposed structure and limiting calculations to those needed to estimate allowable stress and stability, a cost estimate can be provided in a relatively short time. For example, prior art analyses typically require 1-2 days to provide, whereas the embodiment described herein are capable of providing cost estimate information in about a half day or less.

In one embodiment, the processor is configured to construct one or more models of the proposed structure using a plurality of generic panel models. For example, multiple panel models for a variety of structure types and structure components are stored in a database or other suitable location. When constructing and forcing model(s) based on input data, one or more generic panel models are used, which are deformed or modified based on dimension information input by a user. Optionally, a user can add his or her own panel models for use by the processor.

For example, the program retrieves one or more panel models from a suite of generic panel models, and suitable deforms the model or models by an appropriate calculator (e.g., in a spreadsheet) to model the specified configuration.

The generic panel models may be any number of models describing any of various platform types, components or configurations. For example, the program may provide a number of generic platform models corresponding to elemental types. Exemplary generic models include TLP/Semi (four column, four base nodes, four rectangular pontoons), Truss spar (cylindrical hull, heave plates) and Monohull (rectangular with rudimentary bow).

If forcing results are calculated for multiple components of the structure, the program combines the results to calculate global results. For example, results from each model are input to a global performance calculator that outputs the various forces estimated to be applied to the proposed platform after installation.

For example, the workflow 80 shows that the results of the riser calculator 94, the weight calculator 96 and the moorings calculator 98 are input to a global response calculator 100.

In the third stage 73, the forcing results calculated using the various models are output to one or more calculators or modules configured to estimate safety and stability requirements.

Global performance or response results can be used to compute extreme values to be compared against allowable stresses computed, e.g., from API (American Petroleum Institute) “Working Stress Design” Code Equations.

Free-floating platform intact stability may also be assessed. For TLPs, this will mainly govern installation conditions, but other platform types this will also govern the in-place configuration.

The results of the allowable stress and stability calculations are output to a user via a suitable display. In one embodiment, a single output spreadsheet or other type of display/interface is generated that describes the results of the force analyses, allowable stress and/or stability. For example, a user will be able to examine results of all API code checks and the stability checks in a single output spreadsheet. If necessary, changes to the design can then be made until a satisfactory solution is achieved.

For example, the workflow 80 includes a code equations calculator 102 and a stability calculator 104, which receive results from the global response calculator 100. Results of the code checks and stability checks are output to a user, who can decide to change the proposed design if necessary to conform to safety and stability requirements. In one embodiment, the program may evaluate the results from calculators 102, and notify the user if violations are detected. If the design is acceptable, the program continues. If not, the program allows a user to change the proposed design, and the program repeats steps 71-74. In one embodiment, the program is configured to automatically change the design or provide suggestions to the user for changing the design.

In the fourth stage 74, when the design is deemed to be acceptable, the fabrication costs associated with the structure are calculated. These include the costs of purchasing the components based on the proposed design. Any suitable information source, such as manufacturer technical information and product information, may be used to estimate the fabrication costs.

In the fifth stage 75, transportation and installation costs associated with the structure are calculated. The costs are calculated using any available information. In one embodiment, the costs are calculated using estimates provided by potential contractors, such as trucking or transportation contractors and/or assembly/installation contractors.

In one embodiment, the program includes a template or interface to allow the user to input information related to the design, that can be transmitted to contractors to obtain cost estimates. For example, the template allows for a user to describe operations, vessels, and durations that can be effectively used in obtaining estimates from installers.

In the sixth stage 76, total cost estimates are calculated and output to a user. For example, design information and installation information input to an installation module 106 are output to a cost estimator 108 that calculates the total cost estimated for the proposed design.

In one embodiment, the total estimated cost and the results of the force, allowable stress and stability analyses are output to a user via a suitable output module, such as a spreadsheet. In one embodiment, this information is output as a single display or is displayed in a single output to provide the user with easily reviewed and comprehensive information regarding the proposed design and the costs associated therewith.

The embodiments described herein provide numerous advantages. For example, cost estimates are provided by a single program that provides a comprehensive cost estimate. Using this program, a user is allowed to input relevant information and receive cost estimates without having to access additional programs or sources. The embodiments described herein provide integrated tools that enable calculation of all relevant offshore or floating structure characteristics and calculation of cost estimates with minimum user interaction with any other commercial software package.

Prior art systems and methods, in contrast, employ different software packages for various analyses of a platform design. For example, different software packages are typically used to calculate stability, weight estimate, mooring and riser analysis, global response and cost estimate.

In addition, the embodiments described herein provide for the relatively rapid determination of information including the size, characteristics and cost of a floating or offshore structure. The embodiments also provide this information in consistent way.

Generally, some of the teachings herein are reduced to an algorithm that is stored on machine-readable media. The algorithm is implemented by the computer processing system and provides operators with desired output.

In support of the teachings herein, various analysis components may be used, including digital and/or analog systems. The digital and/or analog systems may be included, for example, in a processing device or system such as those described herein, e.g., as the system 10 and/or the processing unit 12. The digital and/or analog systems may include components such as a processor, analog to digital converter, digital to analog converter, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The term “or” when used with a list of at least two items is intended to mean any item or combination of items.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of assessing characteristics of a proposed offshore structure design, the method comprising:
receiving input data from a user via a user interface, the input data including characteristics of a proposed design of an offshore structure;
estimating, by a processor, a weight of the offshore structure and expected forces on the structure based on the input data;
calculating allowable stresses and stability of the offshore structure based on the estimated weight and expected forces;
estimating a cost of fabrication of the offshore structure based on the input data;
estimating a cost of transportation and installation of the offshore structure based on the input data;
calculating a total estimated cost of the offshore structure based on the cost of fabrication and the cost of transportation and assembly; and
outputting the estimated weight, expected forces and total cost to the user via a display.

2. The method of claim 1, wherein the offshore structure is selected from a floating platform and a floating vessel.

3. The method of claim 1, wherein estimating the expected forces includes constructing one or more panel models based on the input data.

4. The method of claim 3, wherein constructing the one or more panel models includes accessing one or more generic panel models from a plurality of stored generic panel models, and modifying the one or more generic panel models based on the input data.

5. The method of claim 4, wherein each of the plurality of generic panel models describes major elements of a different floating platform or floating vessel type.

6. The method of claim 1, wherein the weight is estimated based on top-flight dimensions of the offshore structure, the top-flight dimensions included as the input data.

7. The method of claim 1, further comprising outputting the allowable stress and stability estimates to the user prior to estimating the cost of fabrication and the cost of assembly.

8. The method of claim 7, further comprising, in response to the user changing the proposed design, re-estimating the weight and the expected forces on the structure, and re-estimating the allowable stresses and the stability of the offshore structure.

9. The method of claim 1, wherein calculating the allowable stresses includes calculating extreme force values based on the expected forces and comparing the extreme force values to allowable values calculated based on stress design code equations.

10. The method of claim 1, wherein estimating the cost of transportation and installation includes generating a template including a description of the offshore structure, the description including information needed by an installer, transmitting the template to at least one installer, and receiving an installation estimate from the at least one installer.

11. A system for assessing characteristics of a proposed offshore structure design, the method comprising:
a processing device configured to execute a cost estimate program stored on a machine-readable medium, the cost estimate program including:
an input module configured to receive input data from a user via a user interface, the input data including characteristics of a proposed design of an offshore structure;
an estimation module configured to receive the input data and perform:
estimating a weight of the offshore structure and expected forces on the structure based on the input data;
calculating allowable stresses and stability of the offshore structure based on the estimated weight and expected forces;
estimating a cost of fabrication of the offshore structure based on the input data;
estimating a cost of transportation and installation of the offshore structure based on the input data; and
calculating a total estimated cost of the offshore structure based on the cost of fabrication and the cost of transportation and assembly; and
an output module configured to output and display the estimated weight, expected forces and total cost to the user.

12. The system of claim 11, wherein the offshore structure is selected from a floating platform and a floating vessel.

13. The system of claim 11, wherein estimating the expected forces includes constructing one or more panel models based on the input data.

14. The system of claim 13, wherein constructing the one or more panel models includes accessing one or more generic panel models from a plurality of stored generic panel models, and modifying the one or more generic panel models based on the input data.

15. The system of claim 14, wherein each of the plurality of generic panel models describes major elements of a different floating platform or floating vessel type.

16. The system of claim 11, wherein the estimation module is configured to output the allowable stress and stability estimates to the user prior to estimating the cost of fabrication and the cost of assembly.

17. The system of claim 16, wherein the estimation module is configured to re-estimate the weight and the expected forces on the structure, and re-estimate the allowable stresses and the stability of the offshore structure, in response to the user changing the proposed design by changing the input data.

18. The system of claim 1, wherein estimating the cost of transportation and installation includes generating a template including a description of the offshore structure, the description including information needed by an installer, transmitting the template to at least one installer, and receiving an installation estimate from the at least one installer.

19. The system of claim 1, wherein the processing device is connected to external sources of cost information for a plurality of structure components, and the processor is configured to retrieve the cost information and use the cost information to estimate the cost of fabrication and the cost of transportation and installation.

20. A method of assessing characteristics of a proposed offshore structure design, the method comprising:
receiving input data from a user via a user interface, the input data including characteristics of a proposed design of an offshore structure, the characteristics including a type of structure, dimensions of the structure, a description of components of the structure, and a description of the structure mission and environment for use of the structure;
constructing a panel model of the proposed structure by retrieving one or more generic panel models based on the input data, and modifying the generic panel model based on the dimensions;
estimating, by a processor, a weight of the offshore structure and expected forces on the structure based on the input data;
calculating allowable stresses and stability of the offshore structure based on the estimated weight and expected forces, wherein calculating the allowable stresses includes calculating extreme force values based on the expected forces and comparing the extreme force values to allowable values calculated based on stress design code equations;
outputting the calculated allowable stresses, the comparison and the calculated stability to the user to allow the user to change the proposed design if desired;
estimating a cost of fabrication of the offshore structure based on the input data;
estimating a cost of transportation and installation of the offshore structure based on the input data;
calculating a total estimated cost of the offshore structure based on the cost of fabrication and the cost of transportation and assembly; and
outputting the estimated weight, expected forces and total cost to the user via a display.
